(19) United States
(12) Patent Application Publication
(10) Pub. No.: US 2005/0131117 A1
(43) Pub. Date: Jun. 16, 2005

(54) Methacrylic polymer material with improved fire resistance

(76) Inventors: Jean-Yves Chenard, Pau (FR); Stephanie Pery, Mourenx (FR)

Correspondence Address: Thomas F. Roland, Esq.;Arkema Inc., 2000 Market St., Philadelphia, PA, 19103, US

(21) Appl. No.: 11/000,142

(22) Filed: Nov. 30, 2004

(30) Foreign Application Priority Data
Dec. 12, 2003 (FR) 03.14589
Feb. 20, 2004 (FR) 04.01725

(51) Int. Cl. C08K 5/49; C08K 3/34

(52) U.S. Cl. 524/115; 524/493

(57) ABSTRACT

Light-scattering methacrylic polymer material comprising: from 80 to 90% of a methacrylic (co)polymer; from 5 to 15% of a compatible fire retardant chosen from a halogenated polyphosphonate and a halogenated neutral ester compound of phosphoric acid; and from 1 to 5% of a silica having an elementary particle size of less than 500 nm.

This application claims benefit, under U.S.C. §119(a) of French National Applications Number FR 03.14589, filed Dec. 12, 2003 and FR 04.01725, filed Feb. 20, 2004.

### FIELD OF THE INVENTION

The present invention relates to the field of materials that can be used for the manufacture of articles falling within the electrical field (such as electrical casings) and more particularly within the field of street lighting or display panels in public places such as, for example, emergency exit display panels. More precisely, the subject of the invention is a light-scattering methacrylic polymer material having improved fire resistance.

### BACKGROUND OF THE INVENTION

The benefit afforded by methacrylic (co)polymers in the manufacture of the abovementioned articles, because of their exceptional optical properties, especially their transparency, is known, for example from Application WO 03/037975.

It is also known that these methacrylic (co)polymers pose fire resistance problems that prevent them from being used for manufacturing these articles. This is because such articles are generally subjected to high temperatures, either by the radiation from the light sources that illuminate them or, where appropriate, by undesirable prolonged contact with a heating element. It is for this reason that it is necessary, for the purpose of obtaining materials suitable for manufacturing these articles, to combine these methacrylic (co)polymers with a certain amount of fire retardants.

The aforementioned Application WO 03/037975 thus recommends using, as methacrylic polymer material, a specific combination of a methacrylic (co)polymer containing predominantly methyl methacrylate units with, as fire retardants, at least one halogenated polyphosphonate compound and at least one halogenated neutral ester compound of phosphoric acid.

The materials described by that application are generally in the form of sheets of variable thickness, which are then shaped, especially by thermoforming, cutting and adhesive bonding, in order to obtain the desired articles. However, the fire-retarding effectiveness of the aforementioned compounds greatly decreases with the thickness of these sheets, in such a way that it becomes insufficient for thin sheets.

The object of the present invention is to remedy this drawback without impairing the optical properties otherwise expected of the material. The invention relies on the fact that it has been found that by incorporating a silica specific to the fire retardants described by Application WO 03/037975 it is possible, surprisingly, to improve the fire resistance of the methacrylic polymer material, especially when the latter is in the form of thin sheets, for example with a thickness of between 2.5 and 8 mm.

### SUMMARY OF THE INVENTION

The subject of the present application is therefore a light-scattering methacrylic polymer material comprising:
from 80 to 90% of a methacrylic (co)polymer containing predominantly methyl methacrylate units;
from 5 to 15% of a fire retardant compatible with methyl methacrylate and the metacrylic (co)polymer, the said fire retardant being chosen from a halogenated polyphosphonate compound, a halogenated neutral ester compound of phosphoric acid or a mixture of these two compounds; and
from 1 to 5% of a silica having an elementary particle size of less than 500 nm, preferably less than 100 nm.

### DESCRIPTION OF THE INVENTION

Unless otherwise indicated, the percentages given in the present text are percentages by weight expressed on the basis of the total weight of the polymer material.

The polymer material according to the invention possesses advantageous optical properties in accordance with those expected of the materials used for making luminous devices for illumination, display or indication (for example those intended for advertising panels or illuminated signs), whether they transmit light in the visible spectrum or have a light-scattering power high enough to ensure as uniform an illumination as possible.

The polymer material according to the invention offers these properties combined with quite remarkable fire resistance for an acrylic material. The latter property is measured using a method developed by the IEC (International Electrotechnical Commission) and listed under the number 60695-2-12.

The method consists in applying the end of an incandescent wire, preheated to a known temperature, to the polymer material to be tested, for 30 seconds and with a predetermined force and then, after removal of the wire, in measuring the time for the flames to be extinguished or for the incandescence communicated to the material to disappear.

The material is considered as having successfully passed the test if the flame or incandescence is extinguished in less than 30 seconds after removal of the wire, and to do so in three successive tests. The method starts by heating the incandescent wire to a temperature of 960° C.: should the material fail the test, the temperature of the wire is lowered in steps of 50° C. until a successful test is obtained. The corresponding temperature, called the GWR (Glow Wire Resistance), characterizes the fire resistance of the material, this resistance being better the higher the GWR. This method therefore makes it possible to obtain a relative evaluation of the fire resistance of the materials tested.

The methacrylic (co)polymer containing predominantly methyl methacrylate units comprises from 51 to 100%, preferably 80 to 99%, by weight of units deriving from the methyl methacrylate monomer and from 0 to 49%, preferably 1 to 20%, by weight of units deriving from monoethylenically unsaturated comonomers that can be copolymerized with methyl methacrylate.

The monoethylenically unsaturated comonomer(s) that can be copolymerized with the methyl methacrylate monomer is (are) especially chosen from acrylic, methacrylic and vinyl aromatic monomers.

As acrylic monomers, mention may be made of acrylic acid, alkyl acrylates in which the alkyl group has from 1 to 10 carbon atoms (such as methyl acrylate, ethyl acrylate, n-butyl acrylate, 2-ethylhexyl acrylate and isobutyl acrylate), hydroxyalkyl or alkoxyalkyl acrylates, in which the alkyl group has from 1 to 4 carbon atoms, acrylamide and acrylonitrile.

As methacrylic monomers, mention may be made of methacrylic acid, alkyl methacrylates in which the alkyl group has from 2 to 10 carbon atoms (such as ethyl methacrylate, isobutyl methacrylate, sec-butyl methacrylate and tert-butyl methacrylate), isobornyl methacrylate, methacrylonitrile and hydroxyalkyl or alkoxyalkyl methacrylates in which the alkyl group has from 1 to 4 carbon atoms.

As vinyl aromatic monomers, mention may be made of styrene and substituted styrenes (such as methylstyrene, monochlorostyrene and tert-butylstyrene).

According to a preferred embodiment of the invention, the methacrylic (co)polymer employed in the material according to the invention is a methyl methacrylate homopolymer.

As indicated above, the light-scattering methacrylic polymer material according to the invention furthermore includes from 5 to 15%, preferably 10 to 12%, of a fire retardant compatible with the methyl methacrylate monomer and the methacrylic (co)polymer. The term “compatible” is understood to mean that the said fire retardants mix easily with the methyl methacrylate monomer and the methacrylic (co)polymer and do not demix over time.

The halogenated polyphosphonate compound used is described in Document U.S. Pat. No. 3,058,941. It is preferred to employ a chlorinated polyphosphonate, and in particular the chlorinated polyphosphonate sold by Clariant under the name EXOLIT 5087.

Mention may be made, as examples of halogenated neutral esters of phosphoric acid, of tris(haloalkyl) phosphates in which the halogen is chlorine or bromine and the alkyl group has from 1 to 4 carbon atoms, such as tris(chloromethyl) phosphate, tris(chloroethyl) phosphate, tris(bromomethyl) phosphate, tris(bromoethyl) phosphate, tris(chloropropyl) phosphate, tris(chloroisopropyl) phosphate and tris(bromopropyl) phosphate. Particularly well suited to the methacrylic polymer material according to the invention is tris(2-chloroisopropyl) phosphate (denoted hereafter by TCIP and having 13674-84-5 as a CAS-number).

The silica which is used is preferably a precipitated silica.

According to another embodiment of the invention, where appropriate, taken in combination with the preceding ones, use is made of a silica having an elementary particle size of less than 15 nm, preferably less than 10 nm.

Silicas, in particular precipitated silicas, having an elementary particle size of less than 500 nm, less than 100 nm, or even less than 15 or 10 nm are commercially available.

The expression “elementary particle size” is understood to mean the size that the elementary particle has in the silica aggregate, the aggregate being the smallest non-divisible structure consisting of elementary particles fused together or connected together by strong covalent bonds.

The silica employed according to the invention usually has a high dispersibility, especially in an aqueous medium.

Preferably, it may be a silica according to Patent EP 0 520 862 (or Applications WO 95/09127 or WO 95/09128) and/or prepared using the method described in that patent (or in these applications), the said silica preferably having subsequently undergone a milling operation (especially using a mechanical mill, for example of the Forplex type) or, even more preferably, a micronization operation (in particular using a micronizer, such as an air jet mill).

Before any subsequent micronizing or milling, it may be in the form of granules having a size of between 1 and 10 mm or in the form of a powder having a mean size of between 5 and 70 μm.

Preferably, before any subsequent micronizing or milling it is in the form of approximately spherical beads having a mean size of at least 80 μm, in particular at least 100 μm, for example at least 150 μm, and usually at most 300 μm. This mean size is determined according to the NF X 11507 (December 1970) standard by dry screening and determination of the diameter corresponding to a cumulative screen oversize of 50%. Such a silica in the form of approximately spherical beads can be easily handled and is dust-free, and therefore advantageous from the standpoint of industrial manufacture of the material.

Preferably, the silica used according to the invention results from micronizing a silica in the form of approximately spherical beads, and is then in the form of microbeads. The silica employed according to the invention, when it has been micronized or milled prior to its use, usually possesses, (after this micronizing or milling) a median particle size (especially that measured using a Malvern particle size analyzer) of less than 20 μm, in particular less than 12 μm. Preferably when it has been micronized, its median particle size is at most 5 μm, especially between 0.5 and 5 μm, for example between 1 and 4 μm.

A silica that can be used in the present invention may be obtained, for example, from Rhodia under the name RP 635.

According to a particularly advantageous embodiment of the invention, where appropriate, taken in combination with the preceding ones, the material according to the invention comprises:
from 82 to 86% of the methacrylic (co)polymer;
from 10 to 12% of the fire retardant; and
from 2 to 4% of precipitated silica.

This material may advantageously reach a GWR of greater than or equal to 850° C., and sometimes even 960° C., including when it is in the form of thin sheets, for example with a thickness of between 2.5 and 8 mm.

More precisely, such a material comprises most preferably
from 82 to 86% of the methacrylic (co)polymer;
from 10 to 12% of TCIP; and
from 2 to 4% of silica RP 635.

Apart from the abovementioned constituents, the methacrylic polymer material according to the invention furthermore includes an appropriate amount of one or more light-scattering components, in the form of organic or mineral compound particles of appropriate size. These may be pigments or dyes, such as titanium dioxide, calcium carbonate, calcium sulphate, barium sulphate or carbon black. In general, the weight content range of these compounds in the material is between 0.01 and 5%.

The methacrylic polymer material according to the invention may furthermore optionally contain from 5 to 15% of an impact modifier, as described in Application WO 03/037975.

The methacrylic polymer material according to the invention is advantageously in the form of sheets. These may be manufactured according to the casting process described in Application WO 03/037975.

This process comprises the use of a polymerizable methacrylic composition comprising a polymerizable element in order to form the methacrylic (co)polymer, the fire retardant or retardants, the silica, the light-scattering component and, optionally, the impact modifier. This composition is introduced into a mould consisting of two glass plates separated by a seal made of a polymer (for example polyvinylchlorate) which provides the sealing function, the thickness of the seal determining the thickness of the sheet of material. The mould is placed in a ventilated oven or in a heated bath so as to allow the monomers to polymerize. The polymerization cycle comprises a polymerization step at a temperature of around 50-60° C. in order to obtain a degree of conversion of approximately 95%, followed by a postpolymerization step at a temperature of around 120° C. After cooling, the sheet obtained is removed from the mould. The sheets obtained have a thickness defined by the thickness of the seal.

The polymerizable element essentially consists of methyl methacrylate and, optionally, of monoethylenically unsaturated comonomers that can be copolymerized with methyl methacrylate, such as those mentioned above. The methyl methacrylate may advantageously be replaced with a mixture of the said monomer with a methyl methacrylate prepolymer (called a syrup) having a degree of conversion of 6 to 15%.

The silica used is easily dispersed after mixing it with the methyl methacrylate (or the mixture of the latter with the syrup) under the effect of stirring, even moderate stirring.

Apart from the products defined above, the process for manufacturing the methacrylic polymer material according to the invention also includes, as described in Application WO 03/037975, the addition to the polymerizable composition of at least one radical polymerization initiator, a chain transfer agent, mould release agents, antioxidants or UV stabilizers.

According to a preferred embodiment of the invention, the sheets of the methacrylic polymer material defined above have a thickness of between 2 and 8 mm, preferably between 3 and 6 mm. These thin sheets, having a GWR, and therefore improved safety, allow the applications of the acrylic materials to be diversified in the street lighting or display panel fields.

The following examples are given purely by way of illustration of the invention and should in no case be interpreted as limiting its scope.

### EXAMPLES

### Example 1

3 mm thick sheet of a material comprising 84% polymethyl methacrylate (PMMA), 7% EXOLIT 5087, 5% TCIP and 3.5% silica.

450 g of a polymerizable composition was prepared by adding, in succession, with stirring, to 358.65 g of a methyl methacrylate syrup (hereafter called MMA) the following:
31.5 g (i.e. 7%) of a chlorinated polyphosphonate sold under the name EXOLIT 5087 by Clariant;
22.5 g (i.e. 5%) of TCIP;
15.75 g (i.e. 3.5%) of silica having an elementary particle size of approximetely 12 nm, (RP 635 from Rhodia);
2.25 g (i.e. 0.5%) of BaSO₄ dispersed in dioctyl phthalate;
0.27 g (i.e. 600 ppm) of TiO₂ dispersed in dioctyl phthalate;
2.25 g of a 5% solution of azobis(isobutyronitrile) (AIBN) in MMA, corresponding to 0.1125 g of AIBN (250 ppm);
3.33 g of a 1% solution of terpinene (a chain transfer agent) in MMA, corresponding to 0.0333 g of terpinene (74 ppm); and
13.5 g of a 1% solution of TINUVIN P (UV stabilizer derived from benzotriazole, sold by Ciba-Geigy) in MMA, corresponding to 0.135 g of TINUVIN P (300 ppm).

The polymerizable composition thus obtained was stirred at room temperature until a mixture of uniform appearance was obtained. It was then poured into a mould formed from two glass plates separated by a PVC seal and held in place by clamps in order to obtain a sheet 3 mm in thickness.

The mould, filled and then closed, was then placed horizontally in a fan-assisted oven. The composition was then polymerized for one hour at 68° C. and then for 1 hour 40 minutes at 55° C. The polymerization temperature was then increased over 1 hour until reaching 125° C. and kept at this value for 20 minutes.

After cooling the mould, the parallelepipedal sheet (dimensions: 300×300×3 mm) was demoulded and then cut into square plaques of 50×50×3 mm in order to measure the glow wire resistance (GWR) according to the IEC 60695-2-12 standard.

The GWR obtained was 960° C.

Example A (comparative example according to WO 03/037975):

Example 1 was repeated without incorporating silica.

A GWR of 750° C. was measured.

Example B (control):

Example 1 was repeated without incorporating silica or a fire retardant.

A GWR of 700° C. was measured.

Thus, it has been found that the material according to the invention makes it possible for the GWR of a 3 mm sheet to be appreciably increased (by approximately 200° C.) compared with the material containing no silica prepared according to the teachings of WO 03/037975.

### Example 2

3 mm thick sheet of a material comprising 84% polymethyl methacrylate (PMMA), 5% EXOLIT 5087, 5% TCIP and 3.5% silica.

Example 1 was repeated by modifying the EXOLIT 5087 content and by incorporating 800 ppm of TiO₂ (instead of 600 ppm) and 0.65% of BaSO₄ (instead of 0.5%).

A GWR of 900° C. was measured.

### Example 3

3 mm thick sheet of a material comprising 84% polymethyl methacrylate (PMMA), 12% TCIP and 3.5% silica.

Example 2 was repeated by incorporating 12% TCIP as fire retardant.

A GWR of 850° C. was measured.

### Example 4

4 mm thick sheet of a material comprising 84% polymethyl methacrylate (PMMA), 7% EXOLIT 5087, 5% TCIP and 3.5% silica.

Example 1 was repeated using a PVC seal allowing 4 mm thick sheets to be obtained and without incorporation of BaSO₄.

A GWR of 960° C. was measured.

Example C (comparative example according to WO 03/037975): Example 4 was repeated without incorporating silica.

A GWR of 750° C. was measured.

### Example 5

4 mm thick sheet of a material comprising 84% polymethyl methacrylate (PMMA), 7% EXOLIT 5087, 5% TCIP and 2% silica.

Example 4 was repeated by modifying the silica content and by incorporating 0.5% BaSO₄.

A GWR of 850° C. was measured.

### Example 6

4 mm thick sheet of a material comprising 84% polymethyl methacrylate (PMMA), 5% EXOLIT 5087, 5% TCIP and 3.5% silica.

Example 4 was repeated by modifying the EXOLIT 5087 content and by incorporating 0.5% BaSO₄.

A GWR of 900° C. was measured.

### Example 7

4 mm thick sheet of a material comprising 84% polymethyl methacrylate (PMMA), 12% TCIP and 3.5% silica.

Example 6 was repeated using 12% TCIP as sole fire retardant.

A GWR of 850° C. was measured.

### Example 8

5 mm thick sheet of a material comprising 84% polymethyl methacrylate (PMMA), 5% EXOLIT 5087, 5% TCIP and 3.5% silica.

Example 6 was repeated using a PVC seal allowing 5 mm thick sheets to be obtained and by very slightly modifying the TiO₂ and BaSO₄ content.

A GWR of 900° C. was measured.

### Example 9

6 mm thick sheet of a material comprising 84% polymethyl methacrylate (PMMA), 7% EXOLIT 5087, 5% TCIP and 3.5% silica.

Example 8 was repeated using a PVC seal allowing 6 mm thick sheets to be obtained, by modifying the EXOLIT 5087 content and by adjusting the TiO₂ content.

A GWR of 960° C. was measured.

Example D (comparative example according to WO 03/037975):

Example 9 was repeated without incorporating silica.

A GWR of 900° C. was measured.

The materials illustrated and the results obtained are summarized in Table I below:

TABLE 1

| | Thick- | | | | | |
|---|---|---|---|---|---|---|
| | ness of | | | | Silica | |
| | the | TiO₂ | BaSO₄ | Nature and content | con- | |
| Exam- | sheet | content | content | of the fire | tent | GWR |
| ples | (mm) | (ppm) | (%) | retardants | (%) | (° C.) |
| 1 | 3 | 600 | 0.5 | 7% EXOLIT 5087 + | 3.5 | 960 |
| | | | | 5% TCIP | | |
| A | 3 | 600 | 0.5 | 7% EXOLIT 5087 + | 0 | 750 |
| (com- | | | | 5% TCIP | | |
| para- | | | | | | |
| tive) | | | | | | |
| B | 3 | 600 | 0.5 | none | 0 | 700 |
| (con- | | | | | | |
| trol) | | | | | | |
| 2 | 3 | 800 | 0.65 | 5% EXOLIT 5087 + | 3.5 | 900 |
| | | | | 5% TCIP | | |
| 3 | 3 | 800 | 0.65 | 12% TCIP | 3.5 | 850 |
| 4 | 4 | 600 | 0 | 7% EXOLIT 5087 + | 3.5 | 960 |
| | | | | 5% TCIP | | |
| C | 4 | 600 | 0 | 7% EXOLIT 5087 + | 0 | 750 |
| (com- | | | | 5% TCIP | | |
| para- | | | | | | |
| tive) | | | | | | |
| 5 | 4 | 600 | 0.5 | 7% EXOLIT 5087 + | 2 | 850 |
| | | | | 5% TCIP | | |
| 6 | 4 | 600 | 0.5 | 5% EXOLIT 5087 + | 3.5 | 900 |
| | | | | 5% TCIP | | |

1. Light-scattering methacrylic polymer material comprising:
from 80 to 90 percent by weight of a methacrylic (co)polymer containing predominantly methyl methacrylate units;
from 5 to 15 percent by weight of a fire retardant compatible with the methyl methacrylate monomer and the methacrylic (co)polymer, the said fire retardant being chosen from a halogenated polyphosphonate compound, a halogenated neutral ester compound of phosphoric acid or a mixture of these two compounds; and
from 1 to 5 percent by weight of silica having an elementary particle size of less than 500 nm.

2. The polymer material of claim 1 wherein said silica has an elementary particle size of less than 100 nm.

3. The polymer material according to claim 1, characterized in that the methacrylic (co)polymer employed is a methyl methacrylate homopolymer.

4. The polymer material according to claim 1, characterized in that the halogenated polyphosphonate compound used is a chlorinated polyphosphonate.

5. The polymer material according to claim 1, characterized in that the halogenated neutral ester of phosphoric acid is tris(2-chloroisopropyl) phosphate.

6. The polymer material according to claim 1, characterized in that the silica is a precipitated silica.

7. The polymer material according to claim 1, characterized in that the silica has an elementary particle size of less than 15 nm.

8. The polymer material according to claim 7, characterized in that the silica has an elementary particle size of less than 10 nm.

9. The polymer material according to claim 1, characterized in that it comprises:
from 82 to 86 percent by weight of the methacrylic (co)polymer;
from 10 to 12 percent by weight of the fire retardant; and
from 2 to 4 percent by weight of precipitated silica.

10. The polymer material according to claim 9 characterized in that it comprises:
from 82 to 86 percent by weight of the methacrylic (co)polymer;
from 10 to 12 percent by weight of TCIP;
from 2 to 4 percent by weight of silica RP 635.

11. The polymer material according to claim 1, characterized in that it is in the form of sheets.

12. The polymer material according to claim 11, characterized in that the sheets have a thickness of between 2.5 and 8 mm.

13. The polymer material according to claim 12, characterized in that the sheets have a thickness of between 3 and 6 mm.
